(19) United States
(12) Patent Application Publication
(10) Pub. No.: US 2019/0132574 A1
(43) Pub. Date: May 2, 2019

(54) DEPTH SENSING SYSTEM WITH DIFFERENTIAL IMAGING CAMERA

(71) Applicant: MICROSOFT TECHNOLOGY LICENSING, LLC, Redmond, WA (US)

(72) Inventors: Raymond Kirk PRICE, Redmond, WA (US); Michael BLEYER, Seattle, MA (US); Denis Claude Pierre DEMANDOLX, Bellevue, WA (US)

(21) Appl. No.: 15/799,942

(22) Filed: Oct. 31, 2017

(51) Int. Cl. H04N 13/02

(52) U.S. Cl. CPC H04N 13/0271; H04N 13/0207

(57) ABSTRACT

A depth sensing system includes a scanning laser line projector configured to scan a laser line across a scene within the field of view of a differential imaging camera. The differential imaging camera outputs a stream of data that identifies indices for only pixels that have changed in intensity at continuous points in time. As the laser line is scanned across the scene, a line profile is observed by the differential imaging camera due to a disparity between the location of the scanning laser line projector and the differential imaging camera. The differential imaging camera streams data identifying the indices of pixels located along the line profile that have changed in intensity. A 3D depth map is generated based upon known positions of the laser line and the data received from the differential imaging camera. Scanning of the laser line can also be limited to a region of interest.

### BACKGROUND

Virtual reality (“VR”) devices enable users to view and interact with virtual environments. For example, a VR device might enable a user to explore or interact with a virtual environment. Augmented reality (“AR”) devices enable users to view and interact with virtual objects while simultaneously viewing the physical world around them. For example, an AR device might enable a user to view the placement of virtual furniture in a real-world room. Devices that enable both VR and AR experiences might be referred to as mixed reality (“MR”) devices. VR devices, AR devices, and MR devices are also commonly referred to as near-eye devices (“NED”).

AR and VR devices commonly generate three-dimensional (“3D”) depth maps, or “point clouds,” that contain information describing the distance of surfaces in the surrounding real-world environment to the AR or VR device. AR and VR devices can utilize 3D depth maps for many purposes including, but not limited to, object tracking, generation of a virtual environment that matches the surrounding physical environment, and placement of virtual 3D objects in relation to the physical environment.

AR and VR devices utilize various types of sensors and techniques in order to measure the depth of the surrounding real-world environment. Current systems for depth measurement can, however, be very demanding in their utilization of computing resources such as, but not limited to, processor cycles, data bandwidth, memory, and battery power. Current systems for depth measurement can also generate depth maps that have overall lower resolution than the resolution of the imaging sensor utilized to capture the images used to compute depth.

It is with respect to these and potentially other considerations that the disclosure made herein is presented.

### SUMMARY

A depth sensing system is disclosed herein that includes a scanning laser line projector in combination with a differential imaging camera. Using implementations of the disclosed depth sensing system, such as within computing devices that provide depth sensing functionality like AR and VR devices, 3D depth maps can be generated in a manner that is significantly more computationally efficient than previous solutions. As a result, computing resources, such as processor cycles, data bandwidth, memory, and battery power, can be conserved. Additionally, implementations of the disclosed technologies can generate 3D depth maps that have the same resolution as the differential imaging camera.

According to one configuration, a depth sensing system includes a scanning laser line projector and a differential imaging camera. The scanning laser line projector is configured to scan a laser line across a scene within the field of view (“FOV”) of the differential imaging camera. The differential imaging camera outputs a stream of data that identifies indices for only those pixels that have changed in intensity at continuous points in time. The stream of data can also include data specifying the change in intensity values for the changed pixels and timestamps indicating the point in time at which the pixels changed intensity. The stream of data can include other types of information in other configurations.

As the laser line is scanned across a scene, a distorted view (referred to herein as a “line profile”) of the laser line is observed by the differential imaging camera due to a disparity between the location of the scanning laser line projector and the location of the differential imaging camera. As a result, the differential imaging camera streams data identifying the indices of pixels located along the line profile. In order to minimize data being output for pixels not located along the line profile (i.e. noise) due to camera movement or objects moving in the scene, an optical bandpass filter can be utilized that has a center wavelength that corresponds to the illumination wavelength of the scanning laser line projector.

A 3D depth map of the scene can then be generated based upon known positions of the laser line and the stream of data received from the differential imaging camera. The 3D depth map can then be utilized for various purposes such as, but not limited to, the display of environments or objects by AR or VR devices.

The use of a differential imaging camera in this manner avoids the need for capturing an image for every position of the laser line. Instead, the differential imaging camera reports the indices of pixels whose intensity values have changed at continuous points in time. The list of indices directly represents the matching points in the camera image for all line pixels in the virtual image (i.e. the laser line). Therefore, the stereo matching problem described above is solved in hardware.

In some configurations, an object of interest, such as a hand, can be identified in a scene based upon the 3D depth map, or in another manner. A region of interest can then be identified that encloses the area of interest (e.g. a rectangle surrounding the object of interest). The laser line can then be scanned across only the region of interest (e.g. across only the horizontal FOV of the region of interest) rather than the entire FOV of the differential imaging camera.

In response thereto, the differential imaging camera outputs a stream of data including indices of pixels in the region of interest that change in intensity between frames. The stream of data generated by the differential imaging camera and the known location of the laser line within the region of interest can then be utilized to generate the 3D depth map for the region of interest.

In some configurations, the laser line is scanned across only the region of interest at the same rate utilized to scan the entire FOV of the differential imaging camera, thereby increasing the scan rate of the laser line while consuming the same amount of power. In other configurations, the laser line is scanned across the region of interest at a slower rate than that used to scan the entire FOV of the differential imaging camera. In this manner, the same effective frame rate can be retained for scanning the region of interest, while reducing power consumption. The region of interest can also be continually computed, such as in response to detecting movement of the object of interest.

It should be appreciated that various aspects of the subject matter described briefly above and in further detail below can be implemented as a hardware device, a computer-implemented method, a computer-controlled apparatus or device, a computing system, or an article of manufacture, such as a computer storage medium. While the subject matter described herein is presented in the general context of program modules that execute on one or more computing devices, those skilled in the art will recognize that other implementations can be performed in combination with other types of program modules. Generally, program modules include routines, programs, components, data structures, and other types of structures that perform particular tasks or implement particular abstract data types.

Those skilled in the art will also appreciate that aspects of the subject matter described herein can be practiced on or in conjunction with other computer system configurations beyond those specifically described herein, including multiprocessor systems, microprocessor-based or programmable consumer electronics, video game devices, handheld computers, smartphones, self-driving vehicles, smart watches, e-readers, tablet computing devices, special-purposed hardware devices, network appliances, and the like.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1A and 1B are geometric line diagrams showing aspects of one mechanism for computing the depth of a point in 3D space using stereo image pairs;

FIG. 2 is an imaging system diagram showing aspects of a structured light depth system for computing depth information using a scanning laser line projector and a standard camera imager;

FIG. 3 is an imaging system diagram showing aspects of a structured light depth system for computing depth information using a scanning laser line projector and a differential imaging camera, according to one embodiment disclosed herein;

FIG. 4 is a flow diagram showing aspects of a routine disclosed herein for generating a 3D depth map for a scene using a depth sensing system that includes a differential imaging camera such as that shown in FIG. 3, according to one configuration;

FIGS. 5A and 5B are imaging system diagrams showing aspects of a structured light depth system for generating a 3D depth map for a region of interest in an image frame using a depth sensing system that includes a differential imaging camera, according to one configuration;

FIG. 6 is a flow diagram showing aspects of a routine disclosed herein for generating a 3D depth map for a region of interest in an image frame using a depth sensing system that includes a differential imaging camera such as that shown in FIGS. 5A and 5B, according to one configuration; and

FIG. 7 is a computing device diagram showing aspects of the configuration of an AR device that can be utilized to implement the depth sensing technologies disclosed herein, which include a differential imaging camera.

### DETAILED DESCRIPTION

The following Detailed Description describes a depth sensing system that includes a differential imaging camera. As discussed above, various meaningful technical benefits can be realized through implementations of the disclosed technologies. For example, and as discussed briefly above, implementations of the disclosed subject matter can reduce the utilization of computing resources like processor cycles, memory, bus bandwidth and battery power by computing a 3D depth map for a scene in a more computationally efficient manner than previous solutions. Technical benefits other than those specifically described herein might also be realized through implementations of the disclosed technologies.

Turning now to the figures (which might be referred to herein as a “FIG.” or “FIGS.”), additional details will be provided regarding the depth sensing system disclosed herein with reference to the accompanying drawings that form a part hereof. The FIGS. show, by way of illustration, specific configurations or examples. Like numerals represent like or similar elements throughout the FIGS.

In the FIGS., the left-most digit(s) of a reference number identifies the figure in which the reference number first appears. References made to individual items of a plurality of items can use a reference number with another number included within a parenthetical (and/or a letter without a parenthetical) to refer to each individual item. Generic references to the items might use the specific reference number without the sequence of letters. The drawings are not drawn to scale.

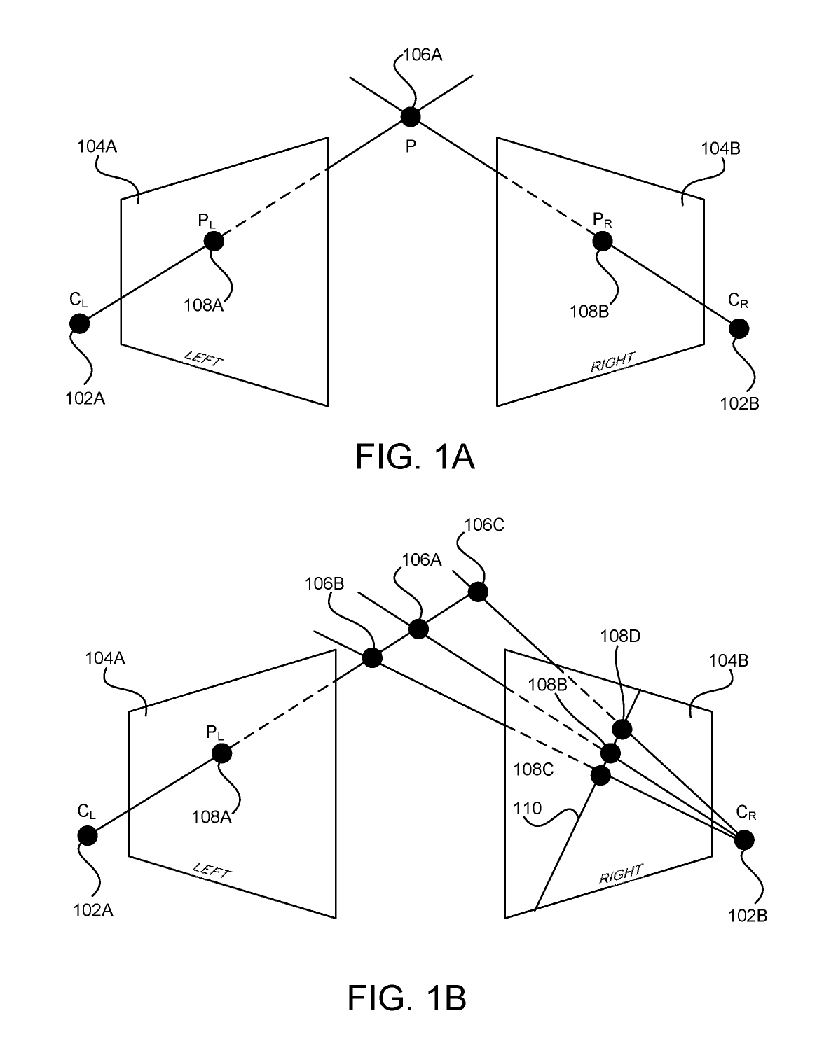

FIGS. 1A and 1B are geometric line diagrams showing aspects of one mechanism for computing the depth of a point in 3D space using stereo image pairs. Prior to discussing the novel depth sensing system disclosed herein and its multiple technical benefits, FIGS. 1A and 1B will be described in order to provide an introduction to several techniques for measuring depth from a scene, and to illustrate at least some of the technical problems associated with such techniques.

One mechanism for measuring depth from a scene, commonly referred to as “depth from stereo,” utilizes two imaging sensors that observe the same scene from different perspectives. A stereo pair of images are generated by the imaging sensors that enable depth estimation via triangulation. FIG. 1A illustrates aspects of this triangulation process.

As shown in FIG. 1A, a camera (which might be referred to herein as the “left camera”) having a focal point 102A can take an image 104A (which might be referred to herein as the “left image”). Another camera (which might be referred to herein as the “right camera”) having a focal point 102B can take a second image 104B (which might be referred to herein as the “right image”) of the same scene from a different perspective. When two images 104 have been captured in this manner, the 3D coordinates of a point in the scene (e.g. the point 106A in FIG. 1A) can be determined by intersecting a ray from the focal point 102A of the left camera to the point 106A and a ray from the focal point 102B of the right camera to the point 106A.

A significant challenge associated with depth from stereo systems is locating the point pairs in the stereo images that represent the 3D projection of the same point. In the example shown in FIG. 1A, for instance, for the ray defined by the point 108A and in the left image 104A it can be computationally difficult to identify the point 108B in the right image 104B that represent the same point in the scene (i.e. the point 106A for which depth is being computed). This challenge is commonly referred to as “the correspondence problem” or “the stereo matching problem.” One mechanism for reducing the complexity of the stereo matching problem is shown in FIG. 1B.

The mechanism illustrated in FIG. 1B utilizes epipolar geometry to reduce the correspondence problem from a two-dimensional (“2D”) search task to a one-dimensional (“1D”) search task. In particular, it can be assumed that the point 106A must lie on the ray from the focal point 102A of the left camera through the point 108A. Consequently, it is sufficient to search only along the projection of this ray into the right image 104B in order to find the point 108B in the right image 104B corresponding to the point 108A in the left image 104A. Projections of points 106A-106C into the right image 104B result in a line 110 having points 108B-108D thereupon. The projected line 110 in the right image 104B is referred to as the “epipolar line.”

Even when leveraging epipolar geometry as shown in FIG. 1B, however, stereo depth generation is computationally expensive and can utilize significant computing resources such as, but not limited to, processor cycles, bus bandwidth, memory, and power. Moreover, such a correspondence search typically returns a depth map that has overall lower resolution than the resolution of the imaging sensor utilized to capture the images 104A and 104B.

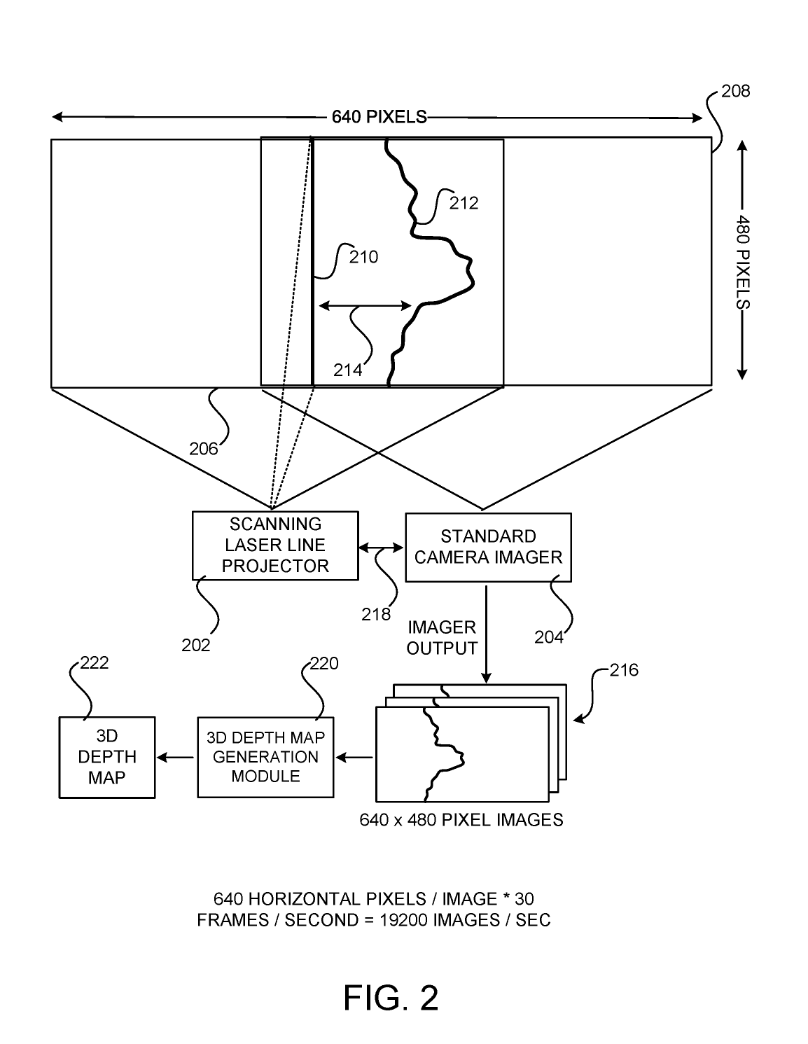

FIG. 2 is an imaging system diagram showing aspects of a structured light depth system for computing depth information using a scanning laser line projector and a standard camera imager. As with regard to FIGS. 1A and 1B, the mechanism shown in FIG. 2 for computing depth will be described in order to provide an introduction to a technique for measuring the depth of a scene, and to illustrate the significant technical problems associated with the illustrated mechanism.

In the structured light depth system shown in FIG. 2, a scanning laser line projector 202 casts a known pattern (e.g. a vertical line laser line 210 as shown in FIG. 2) on a scene. 3D position information for locations in the scene can then be determined based upon an observation of the cast pattern by a standard image sensor 204 and the known projected image pattern (i.e. the vertical line in the example shown in FIG. 2).

In the example configuration shown in FIG. 2, the scanning laser line projector 202 can be thought of as a virtual camera positioned in the same location as one of the cameras in the stereo imaging system described above with regard to FIGS. 1A and 1B. In this case, however, the image projected by the scanning laser line projector 202 is known. The scanning laser line projector 202 is separated from the standard image sensor 204 by a baseline 218. The scanning laser line projector 202 is oriented perpendicularly to the baseline 218 in one configuration.

The scanning laser line projector 202 has a linear field of illumination 206 that at least covers the vertical field of view (“FOV”) 208 of the standard imaging sensor 204. In this example, the standard camera imager 204 has a resolution of 640×480 pixels. It should be appreciated that imagers with other resolutions can be utilized in other configurations. It is also to be appreciated that the 640 horizontal pixels are spread over the entire FOV of the sensor 204 (and the differential imaging camera described below). The disparity between the FOV of the scanning laser line projector 202 and the FOV of the sensor 204 (and the differential imaging camera described below) has been exaggerated in the FIGS. for purposes of illustration.

In the example shown in FIG. 2, the scanning laser line projector 202 generates a laser line 210 that is swept across the horizontal FOV 208 of the standard imaging sensor 204. Objects in the observed scene cause geometric distortion to the laser line 210 observed by the standard imaging sensor 204 as a result of the disparity between the location of the scanning laser line projector 202 and the location of the standard imaging sensor 204. A line profile 212 showing the geometric distortion of the laser line 210 is captured in images 216 generated by the standard camera imager 204.

The disparity 214 between the projected image (i.e. the laser line 210) and the measured image (i.e. the line profile 212) is calculated. The projected image and the disparity 214 between the measured image can then be utilized to compute the 3D position of points in the observed scene utilizing triangulation, such as in the manner described above. In the example configuration shown in FIG. 2, a 3D depth map generation module 220 can consume the images 216 generated by the standard camera imager 204 along with data describing the corresponding position of the laser line 210 and compute a 3D depth map 222 for the observed scene.

As mentioned above, the configuration shown in FIG. 2 utilizes a standard camera imager 204. The standard camera imager 204 takes an image 216 of its entire FOV 208 and outputs the image 216 (e.g. to the 3D depth map generation module 220). In this case, for example, the standard camera imager 204 outputs a 640×480 pixel image 216 each time an image 216 of the observed scene is captured. Such an image 216 might be referred to herein as a “frame.”

In the configuration shown in FIG. 2, the standard camera imager 204 takes an image 216 for each horizontal position of the vertical laser line 210. This means that, in the example configuration, the standard camera imager 204 must take 640 images during each scan of the laser line 210 across the horizontal FOV of the standard camera imager 204. In an implementation where the frame rate of the camera is 30 frames per second, 19200 images 216 having a resolution of 640×480 pixels each must be captured every second (i.e. 640 horizontal pixels*30 frames per second=19200 total camera frames per second). Processing such a large amount of data every second is incredibly computationally expensive and can utilize significant processing cycles, memory, bus bandwidth, and power.

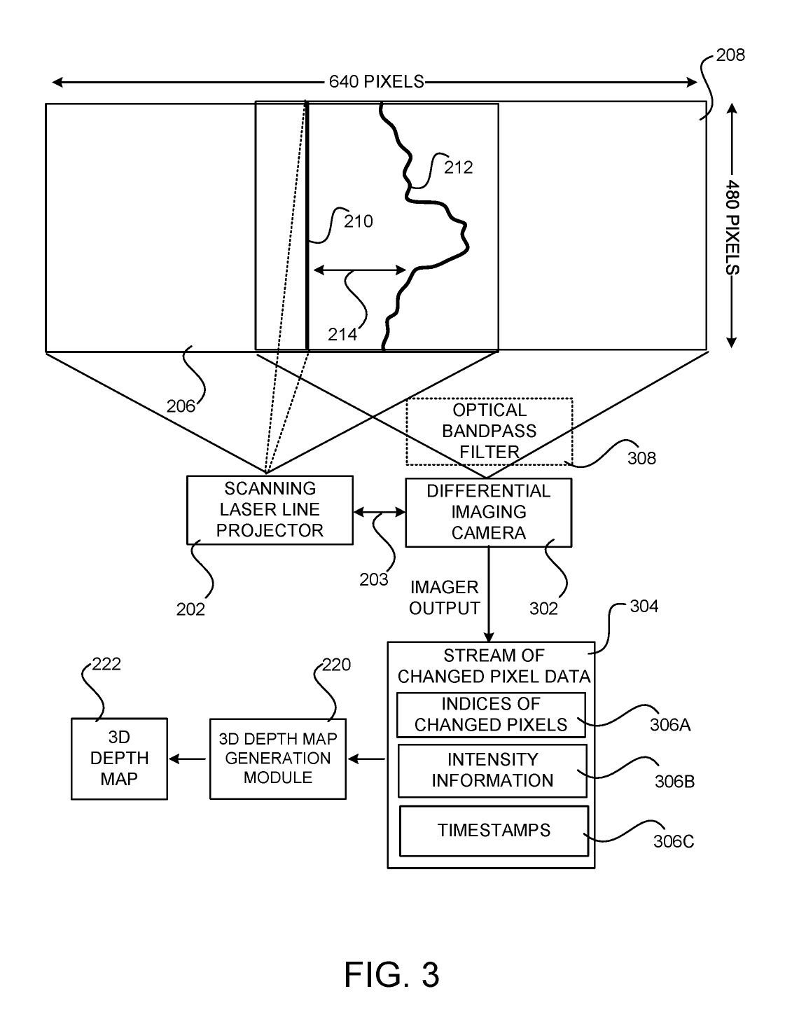

FIG. 3 is an imaging system diagram showing aspects of a structured light depth system for computing depth information using a scanning laser line projector 202 and a differential imaging camera 302, according to one embodiment disclosed herein. The structured light depth system shown in FIG. 3 addresses the technical problems discussed above, and potentially others.

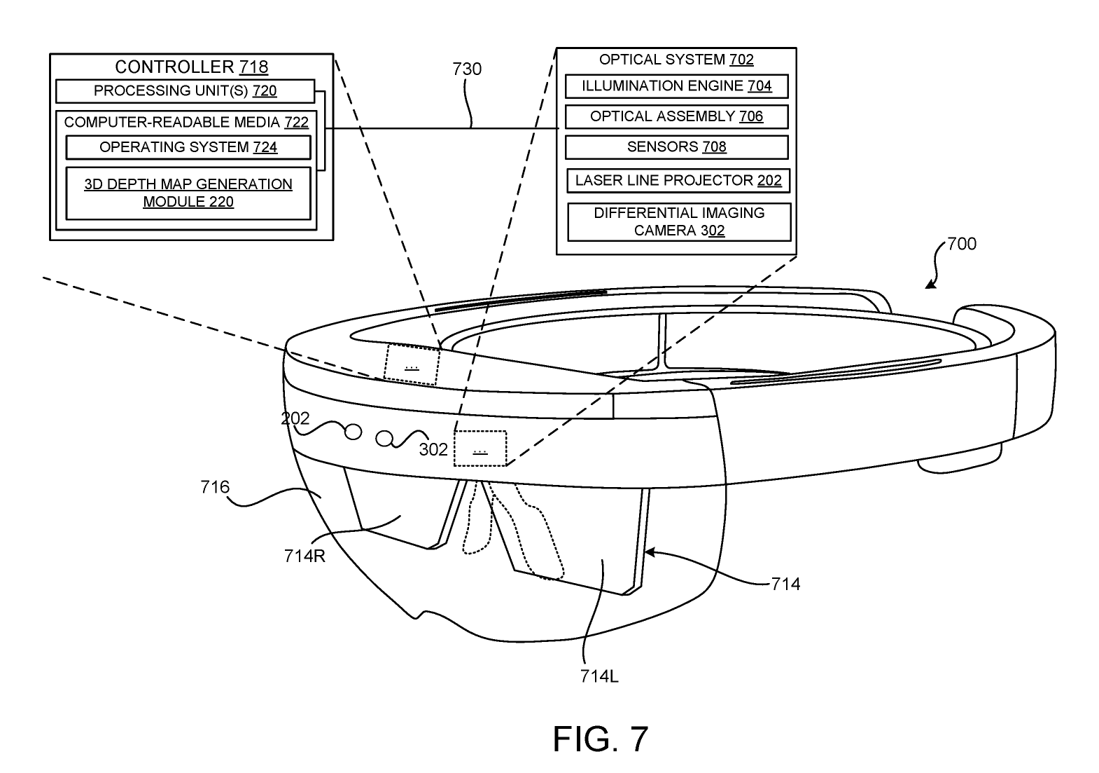

The structured light system shown in FIG. 3 and described herein can be utilized with VR devices or with AR devices, such as the AR device 700 shown in FIG. 7 and described in detail below. Such a device, either alone or in combination with one or more other devices (e.g. a local computer or one or more remotely-located server computers), might form a system that performs or otherwise implements the various processes and techniques described herein. Such a device might take the form of a wearable, head-mounted display device that is worn by a user. It will be understood, however, that such a device might take a variety of different forms other than the specific configurations depicted in the FIGS.

Although the configurations disclosed herein are discussed primarily in the context of AR and VR devices, it is to be further appreciated that the technologies disclosed herein can also be utilized with MR devices, and other types of devices that include functionality for depth sensing such as, but not limited to, smartphones, video game systems, tablet computing devices, smartwatches, and self-driving vehicles.

As mentioned briefly above, the depth sensing system shown in FIG. 3 includes a scanning laser line projector 202 and a differential imaging camera 302. The scanning laser line projector 202 is configured to scan a laser line 210 across a scene within the FOV 208 of the differential imaging camera 302 such as in the manner described above with regard to FIG. 2. In order to provide this functionality, the scanning laser line projector 202 can include a micro-electromechanical (“MEMS”) mirror coupled, a laser diode, and suitable diffractive optical elements (“DOE”). The angular position of the scanning laser line projector 202 can also be recorded along with a timestamp indicating the time at which the projector was at the recorded angular position.

In contrast to a standard imaging camera such as that described above with regard to FIG. 2, however, the differential imaging camera 302 outputs a stream of changed pixel data 304 (which might be referred to simply as a “stream of data 304”) that includes data 306A identifying the indices for only those pixels in a frame that have changed in intensity at continuous points in time. The stream of data 304 can also include data 306B specifying the change in intensity values for the changed pixels and timestamps 306C for the changed pixels indicating the time at which their intensity changed. The stream of data 304 can include other types of information in other configurations.

As the laser line 210 is scanned across the FOV 208 of the differential imaging camera 302, a distorted line profile 212 of the laser line is observed by the differential imaging camera 302 due to a disparity between the location of the scanning laser line projector 202 and the location of the differential imaging camera 302. As a result, the differential imaging camera 302 streams data 306A identifying the indices of changed pixels located along the line profile 212. In order to minimize data 306A being output for pixels not located along the line profile 212 (i.e. noise), an optical bandpass filter 308 can be utilized that has a center wavelength that corresponds to the illumination wavelength of the scanning laser line projector 302.

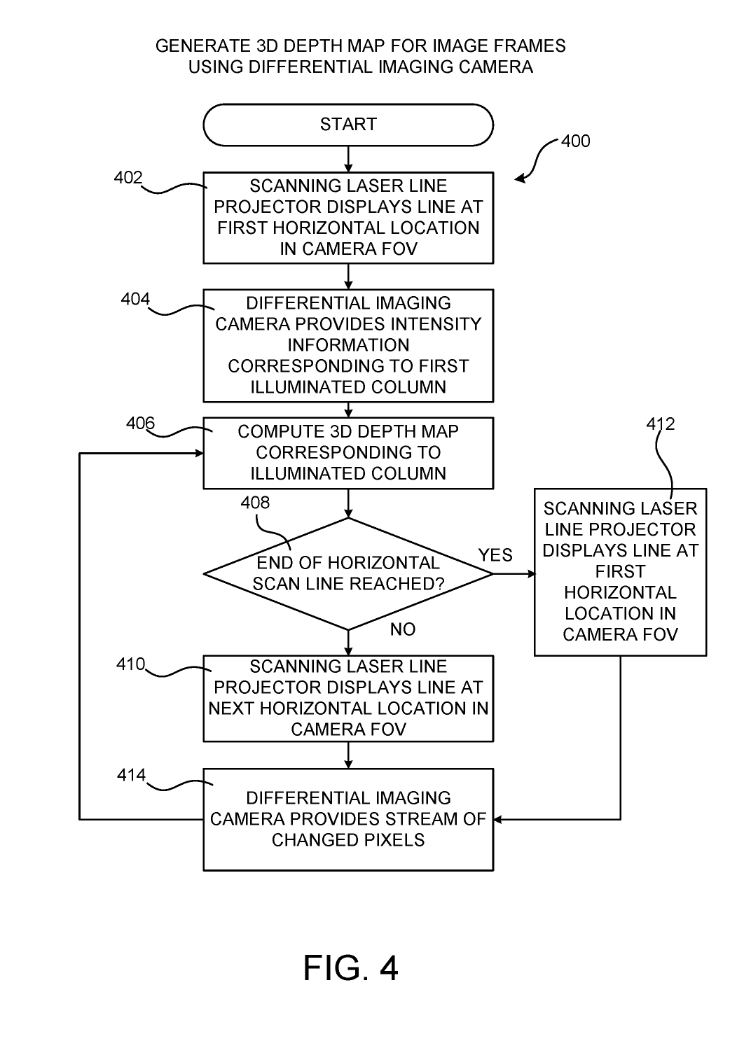

A 3D depth map generation module 220 can then generate a 3D depth map 222 of the scene in the FOV 208 of the differential imaging camera 302 based upon known positions of the laser line 210 and the stream of data 304 received from the differential imaging camera 302. The 3D depth map 222 can then be utilized for various purposes such as, but not limited to, the display of environments or objects by AR or VR devices. Additional details regarding the operation of the structured light system shown in FIG. 3 will be described below with regard to FIG. 4.

FIG. 4 is a flow diagram showing aspects of a routine 400 disclosed herein for generating a 3D depth map 222 for a scene using a depth sensing system such as that shown in FIG. 3 and described above that includes a differential imaging camera 302, according to one configuration. The routine 400 is illustrated as a collection of blocks in a logical flow graph, which represent a sequence of operations that can be implemented in hardware, software, or a combination thereof. In the context of software, the illustrated blocks represent computer-executable instructions that, when executed by one or more processors, perform the recited operations.

Generally, computer-executable instructions include routines, programs, objects, components, data structures, and the like that perform or implement particular functions. The order in which operations are described herein is not intended to be construed as a limitation, and any number of the described blocks can be combined in any order and/or in parallel to implement the disclosed processes. Other processes described throughout this disclosure shall be interpreted accordingly.

The routine 400 begins at operation 402, where the scanning laser line projector 202 displays the laser line 210 at a first horizontal location in the FOV 208 of the differential imaging camera 302. For example, the laser line 210 might first be displayed at the leftmost position of the FOV 208 of the differential imaging camera 302. The routine 400 then proceeds from operation 402 to operation 404.

At operation 404, the differential imaging camera 302 outputs data 306B describing the intensity of pixels in the first illuminated column. In this regard, it is to be appreciated that intensity information for all pixels in the FOV 208 will be provided once by the differential imaging camera 302. Subsequently, only indices for pixels having a change in intensity are output. From operation 404, the routine 400 proceeds to operation 406.

At operation 406, the 3D depth map generation module 220 computes the 3D depth map 222 corresponding to the illuminated column using the stream of data 304 provided by the differential imaging camera 302. The routine 400 then proceeds to operation 408, where a determination is made as to whether the laser line 210 has reached the last horizontal scan line. For example, a determination can be made as to whether the laser line 210 has reached right-most position in the FOV 208 of the differential imaging camera 302.

If the end of the frame has been reached, the routine 400 proceeds from operation 408 to operation 412. At operation 412, the scanning laser line projector 202 returns the laser line 210 to the first horizontal location in the camera FOV 208. For example, the laser line 210 can be presented at the left-most position in the FOV 208 of the differential imaging camera 302.

If the end of the frame has not been reached, the routine 400 proceeds from operation 408 to operation 410. At operation 410, the scanning laser line projector 202 displays the laser line 210 at the next horizontal location in the FOV 208 of the differential imaging camera 302. In this manner, the laser line 210 can be continually scanned horizontally across the FOV 208 of the differential imaging camera 302. From operations 410 and 412, the routine 400 proceeds to operation 414.

At operation 414, the stream of data 304 is provided to the 3D depth map generation module 220. As discussed above, the stream of data 304 includes data 306A identifying the indices for only those pixels in the frame that have changed in intensity at continuous points in time, data 306B describing the change in intensity of the identified pixels, and data 306C providing timestamps associated with the changed pixels.

The routine 400 then proceeds from operation 414 to operation 406, where the 3D depth map generation module 220 computes the 3D depth map 222 using the stream of data 304 provided by the differential imaging camera 302. In particular, the 3D depth map generation module 220 can utilize the timestamped stream of data 304 provided by the differential imaging camera 302 along with the timestamped data identifying the angular position of the scanning laser line projector 202 to compute the 3D depth map 222 in the manner described above. The routine 400 then continues in the manner described above so the laser line 210 can be continually swept across the FOV 208 and the 3D depth map 222 can be updated.

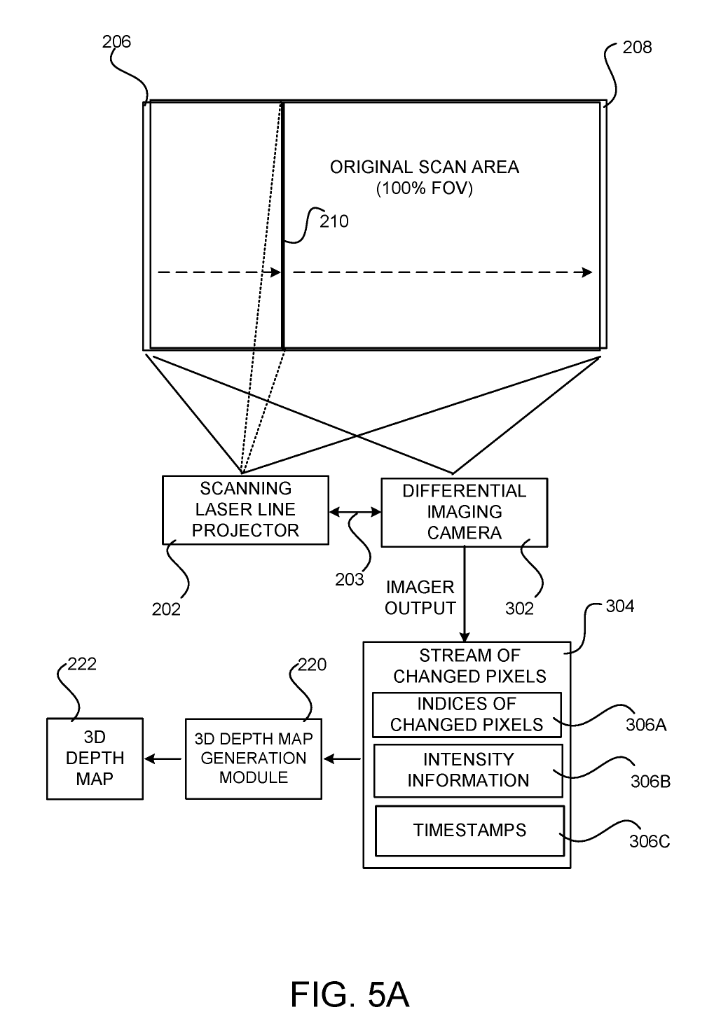

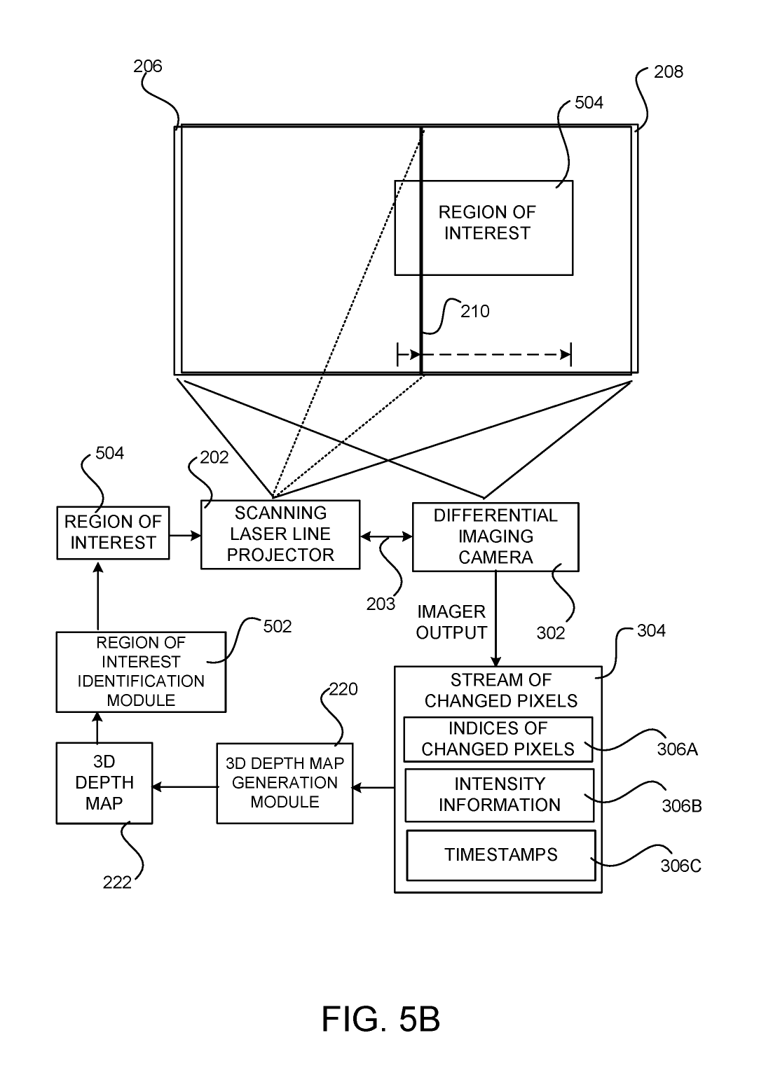

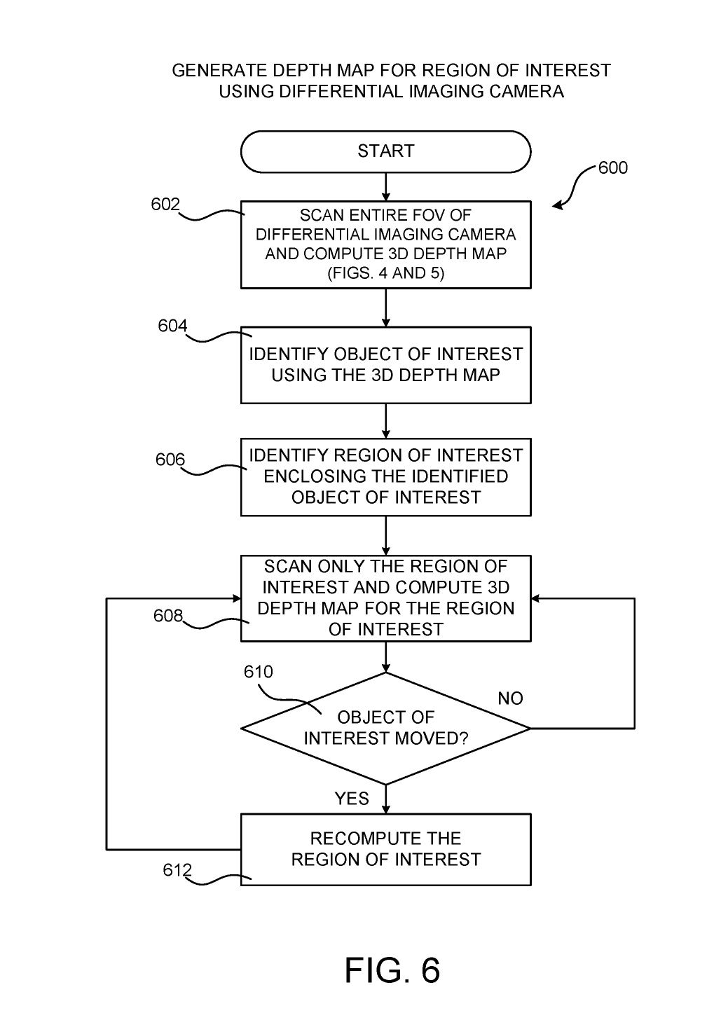

FIGS. 5A and 5B are imaging system diagrams showing aspects of a structured light depth system for generating a 3D depth map 222 for a region of interest in an image frame using a depth sensing system that includes a differential imaging camera 302 such as that described above, according to one configuration. As shown in FIG. 5A and described above, in one configuration the scanning laser line projector 202 scans the laser line 210 across the entire FOV 208 of the differential imaging camera 302.

Many applications, however, do not require a 3D depth map 222 that covers the entire FOV 208 of the differential imaging camera 302. Moreover, the frame rate of the system shown in FIG. 5A is limited by the time the scanning laser line projector 202 needs to scan the FOV 208 of the differential imaging camera 302. The configuration illustrated in FIG. 5B addresses these considerations, and potentially others, and provides additional technical benefits, including a higher scan rate and lower power consumption.

In the configuration shown in FIG. 5B, a 3D depth map 222 is computed for the entire FOV 208 of the differential imaging camera 302 (as shown in FIG. 5A). To compute the first 3D depth map 222, the laser line 210 traverses the entire FOV 208 of the differential imaging camera 302. The first 3D depth map 222 is then provided to a region of interest (“ROI”) identification module 502. The ROI identification module 502 is a software module that can identify an object of interest.

An object of interest might, for example, be a hand, a person for skeletal tracking, or another type of object. Once the object of interest has been identified, a ROI 504 can be identified that encloses the object of interest. The scan area of the scanning laser line projector 202 is then updated to encompass only the ROI 504. In the example shown in FIG. 5B, for example, the scan area only encompasses the horizontal width of the ROI 504.

In response to scanning only the ROI 504, the differential imaging camera 302 outputs a stream of data 304 including indices of pixels in the ROI 504 that have changed in intensity. The stream of data 304 generated by the differential imaging camera 302 and the known location of the laser line 210 within the ROI 504 can then be utilized in the manner described above to generate the 3D depth map 222 for the region of interest 504.

In some configurations, the laser line 210 is scanned across the region of interest 504 only at the same rate utilized to scan the entire FOV 208 of the differential imaging camera 302, thereby increasing the effective scan rate of the laser line 210 while consuming the same amount of power as required to scan the entire FOV 208 because the amount of emitted photons stays the same. As stated above, the frame rate of the differential imaging camera 302 is determined by the time the laser line 210 needs to scan the scene once. Hence, a higher frame rate can be achieved by reducing the area the laser line 210 needs to traverse.

In one specific example, the ROI 504 is one-fifth the size of the FOV 208 of the differential imaging camera 302. In this example, a five times higher frame rate can be achieved as compared to scanning the entire FOV 504. In the context of hand tracking, for instance, obtaining 3D depth maps 222 of the hand at very high frame rates enables reliable articulated hand tracking, particularly in situations where the hand is moving very fast.

In other configurations, the laser line 210 is scanned across the ROI 504 at a slower rate than that used to scan the entire FOV 208 of the differential imaging camera 302. In this manner, the same effective frame rate can be retained for scanning the ROI 504 as for scanning the entire FOV 208, while reducing power consumption because the laser line 210 does not need to illuminate areas outside the ROI 504. The ROI 504 can also be continually updated, such as in response to detecting movement of the ROI 504. Additional details regarding the mechanism shown in FIG. 5B and described above will be provided below with regard to FIG. 6.

FIG. 6 is a flow diagram showing aspects of a routine 600 disclosed herein for generating a 3D depth map 222 for a region of interest 504 in an image frame using a depth sensing system that includes a differential imaging camera 302, according to one configuration. The routine 600 begins at operation 602, where the entire FOV 208 of the differential imaging camera 302 is scanned and a 3D depth map 222 is generated in the manner described above with regard to FIGS. 4 and 5.

From operation 602, the routine 600 proceeds to operation 604, where the 3D depth map 222 is provided to the ROI identification module 502. The ROI identification module 502 identifies an object of interest using the 3D depth map 222. The object of interest can be identified in other ways in other configurations. The routine 600 then proceeds from operation 604 to operation 606, where the ROI identification module 502 identifies a ROI 504 that encloses the identified object of interest. The ROI 504 might be, for example, a rectangle surrounding the object of interest.

From operation 606, the routine 600 proceeds to operation 608, where the scanning laser line projector 202 scans only the ROI 504. A 3D depth map 222 is then generated for the ROI 504 in the manner described above. The routine 600 then proceeds from operation 608 to operation 610, where the ROI identification module 502 determines whether the object of interest has moved. If so, the routine 600 proceeds from operation 610 to operation 612, where the ROI 504 is recomputed based upon the new location of the object of interest. The routine 600 then proceeds back to operation 608, where the new ROI 504 is again scanned in the manner described above. If the location of the object of interest has not changed, the routine 600 proceeds from operation 610 to operation 608.

FIG. 7 is a computing device diagram showing aspects of the configuration of an AR device 700 that implements and utilizes the depth sensing system disclosed herein. As described briefly above, AR devices superimpose computer generated (“CG”) images over a user's view of a real-world environment. For example, an AR device 700 such as that shown in FIG. 7 might generate composite views to enable a user to visually perceive a CG image superimposed over a view of a physical object that exists within a real-world environment. As also described above, the technologies disclosed herein can be utilized with AR devices such as that shown in FIG. 7, VR devices, MR devices, NED devices, and other types of devices that utilize depth sensing.

In the example shown in FIG. 7, an optical system 702 includes an illumination engine 704 to generate electromagnetic (“EM”) radiation that includes both a first bandwidth for generating CG images and a second bandwidth for tracking physical objects. The first bandwidth may include some or all of the visible-light portion of the EM spectrum whereas the second bandwidth may include any portion of the EM spectrum that is suitable to deploy a desired tracking protocol. In this example, the optical system 702 further includes an optical assembly 706 that is positioned to receive the EM radiation from the illumination engine 704 and to direct the EM radiation (or individual bandwidths thereof) along one or more predetermined optical paths.

For example, the illumination engine 704 may emit the EM radiation into the optical assembly 706 along a common optical path that is shared by both the first bandwidth and the second bandwidth. The optical assembly 706 may also include one or more optical components that are configured to separate the first bandwidth from the second bandwidth (e.g., by causing the first and second bandwidths to propagate along different image-generation and object-tracking optical paths, respectively).

In some instances, a user experience is dependent on the AR device 700 accurately identifying characteristics of a physical object or plane (such as the real-world floor) and then generating the CG image in accordance with these identified characteristics. For example, suppose that the AR device 700 is programmed to generate a user perception that a virtual gaming character is running towards and ultimately jumping over a real-world structure. To achieve this user perception, the AR device 700 might obtain detailed data defining features of the real-world terrain around the AR device 700. As discussed above, in order to provide this functionality, the optical system 702 of the AR device 700 can include a laser line projector 202 and a differential imaging camera 302 configured in the manner described herein.

In some examples, the AR device 700 utilizes an optical system 702 to generate a composite view (e.g., from a perspective of a user that is wearing the AR device 700) that includes both one or more CG images and a view of at least a portion of the real-world environment. For example, the optical system 702 might utilize various technologies such as, for example, AR technologies to generate composite views that include CG images superimposed over a real-world view. As such, the optical system 702 might be configured to generate CG images via an optical assembly 706 that includes a display panel 714.

In the illustrated example, the display panel includes separate right eye and left eye transparent display panels, labeled 714R and 714L, respectively. In some examples, the display panel 714 includes a single transparent display panel that is viewable with both eyes or a single transparent display panel that is viewable by a single eye only. Therefore, it can be appreciated that the techniques described herein might be deployed within a single-eye device (e.g. the GOOGLE GLASS AR device) and within a dual-eye device (e.g. the MICROSOFT HOLOLENS AR device).

Light received from the real-world environment passes through the see-through display panel 714 to the eye or eyes of the user. Graphical content displayed by right-eye and left-eye display panels, if configured as see-through display panels, might be used to visually augment or otherwise modify the real-world environment viewed by the user through the see-through display panels 714. In this configuration, the user is able to view virtual objects that do not exist within the real-world environment at the same time that the user views physical objects within the real-world environment. This creates an illusion or appearance that the virtual objects are physical objects or physically present light-based effects located within the real-world environment.

In some examples, the display panel 714 is a waveguide display that includes one or more diffractive optical elements (“DOEs”) for in-coupling incident light into the waveguide, expanding the incident light in one or more directions for exit pupil expansion, and/or out-coupling the incident light out of the waveguide (e.g., toward a user's eye). In some examples, the AR device 700 further includes an additional see-through optical component, shown in FIG. 7 in the form of a transparent veil 716 positioned between the real-world environment and the display panel 714. It can be appreciated that the transparent veil 716 might be included in the AR device 700 for purely aesthetic and/or protective purposes.

The AR device 700 might further include various other components (not all of which are shown in FIG. 7), for example, front-facing cameras (e.g. red/green/blue (“RGB”), black & white (“B&W”), or infrared (“IR”) cameras), speakers, microphones, accelerometers, gyroscopes, magnetometers, temperature sensors, touch sensors, biometric sensors, other image sensors, energy-storage components (e.g. battery), a communication facility, a global positioning system (“GPS”) a receiver, the laser line projector 202, the differential imaging camera 302, and, potentially, other types of sensors. Data obtained from one or more sensors 708, some of which are identified above, can be utilized to determine the orientation, location, and movement of the AR device 700. As discussed above, data obtained from the differential imaging camera 302 and the laser line projector 202 can also be utilized to generate a 3D depth map 222 of the surrounding physical environment.

In the illustrated example, the AR device 700 includes one or more logic devices and one or more computer memory devices storing instructions executable by the logic device(s) to implement the functionality disclosed herein. In particular, a controller 718 can include one or more processing units 720, one or more computer-readable media 722 for storing an operating system 724, other programs (such as the 3D depth map generation module 220 configured to generate the 3D depth map 222) in the manner disclosed herein), and data.

In some implementations, the AR device 700 is configured to analyze data obtained by the sensors 708 to perform feature-based tracking of an orientation of the AR device 700. For example, in a scenario in which the object data includes an indication of a stationary object within the real-world environment (e.g., a table), the AR device 700 might monitor a position of the stationary object within a terrain-mapping field-of-view (“FOV”). Then, based on changes in the position of the stationary object within the terrain-mapping FOV and a depth of the stationary object from the AR device 700, the AR device 700 might calculate changes in the orientation of the AR device 700.

It can be appreciated that these feature-based tracking techniques might be used to monitor changes in the orientation of the AR device 700 for the purpose of monitoring an orientation of a user's head (e.g., under the presumption that the AR device 700 is being properly worn by a user). The computed orientation of the AR device 700 can be utilized in various ways, some of which have been described above.

The processing unit(s) 720, can represent, for example, a central processing unit (“CPU”)-type processor, a graphics processing unit (“GPU”)-type processing unit, a field-programmable gate array (“FPGA)”, one or more digital signal processors (“DSPs”), or other hardware logic components that might, in some instances, be driven by a CPU. For example, and without limitation, illustrative types of hardware logic components that can be used include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As used herein, computer-readable media, such as computer-readable media 722, can store instructions executable by the processing unit(s) 720, such as instructions which, when executed, compute the depth of a real-world floor in the manner disclosed herein. Computer-readable media can also store instructions executable by external processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media can include computer storage media and/or communication media. Computer storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data.

Thus, computer storage media includes tangible and/or physical forms of media included in a device and/or hardware component that is part of a device or external to a device, including but not limited to random access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, rotating media, optical cards or other optical storage media, magnetic storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media can embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

### EXAMPLE CLAUSES

The disclosure presented herein also encompasses the subject matter set forth in the following clauses:

Clause 1. A device (700), comprising: a scanning laser line projector (202); a differential imaging camera (302); a processor (720); and a computer storage medium (722) having instructions stored thereupon which, when executed by the processor (720), cause the device (700) to: cause the scanning laser line projector (202) to scan a laser line (210) across a scene within a field of view (FOV) (208) of the differential imaging camera (302); receive, by way of the processor, a stream of data (304) from the differential imaging camera (302), the stream of data (304) identifying indices of pixels captured by the differential imaging camera (302) that have changed in intensity at continuous points in time; and compute, by way of the processor, a three-dimensional (3D) depth map (222) of the scene within the FOV (208) of the differential imaging camera (302) based upon known positions of the laser line (210) within the FOV (208) of the differential imaging camera (302) and the stream of data (304) received from the differential imaging camera (302).

Clause 2. The device of clause 1, wherein the stream of data further comprises data identifying a change in intensity of the pixels captured by the differential imaging camera and timestamps corresponding to the pixels.

Clause 3. The device of any of clauses 1 or 2, wherein the scanning laser line projector is configured to provide timestamped data describing an angular position of the laser line, and wherein the 3D depth map is computed based upon the stream of data and the timestamped data describing the angular position of the laser line.

Clause 4. The device of any of clauses 1 to 3, wherein the pixels define a line profile corresponding to the laser line, the line profile being observed by the differential imaging camera due to a disparity between a location of the scanning laser line projector and a location of the differential imaging camera.

Clause 5. The device of any of clauses 1 to 4, further comprising an optical bandpass filter having a center wavelength corresponding to an illumination wavelength of the scanning laser line projector.

Clause 6. The device of any of clauses 1 to 5, wherein the computer storage medium has further instructions stored thereupon to cause the scanning laser line projector to scan the laser line across only a region of interest in the FOV of the differential imaging camera, the region of interest enclosing an object of interest.

Clause 7. The device of any of clauses 1 to 6, wherein the computer storage medium has further instructions stored thereupon to cause the scanning laser line projector to scan the laser line across only a second region of interest in the FOV of the differential imaging camera, the second region of interest enclosing the object of interest and being calculated responsive to movement of the object of interest.

Clause 8. A computer-implemented method for generating a three-dimensional (3D) depth map of a scene, the method comprising: scanning a laser line (210) across the scene, the scene located within a field of view (FOV) (208) of a differential imaging camera (302); receiving a stream of data (304) from the differential imaging camera (302), the stream of data (304) identifying indices of pixels captured by the differential imaging camera (302) that have changed in intensity at continuous points in time; and generating the 3D depth map (222) of the scene within the FOV (208) of the differential imaging camera (302) based upon known positions of the laser line (210) within the FOV (208) of the differential imaging camera (302) and the stream of data (304) received from the differential imaging camera (302).

Clause 9. The computer-implemented method of clause 8, wherein the stream of data further comprises data identifying a change in intensity of the pixels captured by the differential imaging camera.

Clause 10. The computer-implemented method of clauses 8 or 9, wherein the stream of data further comprises timestamps corresponding to the pixels.

Clause 11. The computer-implemented method of any of clauses 8 to 10, wherein the pixels define a line profile corresponding to the laser line, the line profile being observed by the differential imaging camera due to a disparity between a location of the scanning laser line projector and a location of the differential imaging camera.

Clause 12. The computer-implemented method of any of clauses 8 to 11, wherein the differential imaging camera further comprises an optical bandpass filter having a center wavelength corresponding to an illumination wavelength of the scanning laser line projector.

Clause 13. The computer-implemented method of any of clauses 8 to 12, further comprising scanning the laser line across only a region of interest in the FOV of the differential imaging camera, the region of interest enclosing an object of interest.

Clause 14. The computer-implemented method of any of clause 8 to 13, further comprising scanning the laser line across only a second region of interest in the FOV of the differential imaging camera, the second region of interest enclosing the object of interest and being calculated responsive to movement of the object of interest.

Clause 15. A device (700), comprising: a scanning laser line projector (202);

a differential imaging camera (302); a processor (720); and a computer storage medium (722) having instructions stored thereupon which, when executed by the processor (720), cause the device (700) to: cause the scanning laser line projector (202) to scan a laser line (210) across only a region of interest (504) within a field of view (FOV) (208) of the differential imaging camera (302); receive a stream of data (304) from the differential imaging camera (302), the stream of data (304) identifying indices of only pixels captured by the differential imaging camera (302) that have changed in intensity at continuous points in time; and generate a 3D depth map (222) of the region of interest (504) based upon the stream of data (304) received from the differential imaging camera (302) and known positions of the laser line (210) within the region of interest (504).

Clause 16. The device of clause 15, wherein the laser line is scanned across the region of interest at a rate equivalent to a rate used to scan the laser line across the entire FOV of the differential imaging camera.

Clause 17. The device of clauses 15 or 16, wherein the laser line is scanned across the region of interest at a rate that is slower than a rate used to scan the laser line across the entire FOV of the differential imaging camera.

Clause 18. The device of any of clauses 15 to 17, wherein the region of interest encloses an object of interest, and wherein the computer storage medium has further instructions stored thereupon to scan the laser line across only a second region of interest in the FOV of the differential imaging camera, the second region of interest enclosing the object of interest and being calculated responsive to movement of the object of interest.

Clause 19. The device of any of clauses 15 to 18, further comprising an optical bandpass filter having a center wavelength corresponding to an illumination wavelength of the scanning laser line projector.

Clause 20. The device of any of clauses 15 to 19, wherein the stream of data further comprises data identifying a change in intensity of the pixels captured by the differential imaging camera and timestamps corresponding to the pixels.

Based on the foregoing, it should be appreciated that a depth sensing system has been disclosed herein that includes a differential imaging camera. The disclosed system provides important technical benefits, thereby overcoming technical problems with previous depth sensing systems. These technical benefits result in significant improvements to depth sensing technology in general and, more specifically, to computing devices that utilize depth sensing technology. As discussed above, these improvements can include, but are not limited to, lower processor, memory, bus bandwidth, and power consumption as compared to previous depth sensing technologies. Other technical benefits might also be realized through implementations of the disclosed technologies.

Although the subject matter presented herein has been described in language specific to hardware configurations, computer structural features, methodological acts, and computer readable media, it is to be understood that the invention defined in the appended claims is not necessarily limited to the specific features, acts, or media described herein. Rather, the specific features, acts, and media are disclosed as example forms of implementing the claims.

The subject matter described above is provided by way of illustration only and should not be construed as limiting. Furthermore, the claimed subject matter is not limited to implementations that solve any or all disadvantages noted in any part of this disclosure. Various modifications and changes can be made to the subject matter described herein without following the example configurations and applications illustrated and described, and without departing from the true spirit and scope of the present invention, which is set forth in the claims below.

What is claimed is:

1. A device, comprising:
a scanning laser line projector;
a differential imaging camera;
a processor; and
a computer storage medium having instructions stored thereupon which, when executed by the processor, cause the device to:
cause the scanning laser line projector to scan a laser line across a scene within a field of view (FOV) of the differential imaging camera;
receive, by way of the processor, a stream of data from the differential imaging camera, the stream of data identifying indices of pixels captured by the differential imaging camera that have changed in intensity at continuous points in time; and
compute, by way of the processor, a three-dimensional (3D) depth map of the scene within the FOV of the differential imaging camera based upon known positions of the laser line within the FOV of the differential imaging camera and the stream of data received from the differential imaging camera.

2. The device of claim 1, wherein the stream of data further comprises data identifying a change in intensity of the pixels captured by the differential imaging camera and timestamps corresponding to the pixels.

3. The device of claim 2, wherein the scanning laser line projector is configured to provide timestamped data describing an angular position of the laser line, and wherein the 3D depth map is computed based upon the stream of data and the timestamped data describing the angular position of the laser line.

4. The device of claim 1, wherein the pixels define a line profile corresponding to the laser line, the line profile being observed by the differential imaging camera due to a disparity between a location of the scanning laser line projector and a location of the differential imaging camera.

5. The device of claim 1, further comprising an optical bandpass filter having a center wavelength corresponding to an illumination wavelength of the scanning laser line projector.

6. The device of claim 1, wherein the computer storage medium has further instructions stored thereupon to cause the scanning laser line projector to scan the laser line across only a region of interest in the FOV of the differential imaging camera, the region of interest enclosing an object of interest.

7. The device of claim 6, wherein the computer storage medium has further instructions stored thereupon to cause the scanning laser line projector to scan the laser line across only a second region of interest in the FOV of the differential imaging camera, the second region of interest enclosing the object of interest and being calculated responsive to movement of the object of interest.

8. A computer-implemented method for generating a three-dimensional (3D) depth map of a scene, the method comprising:
scanning a laser line across the scene, the scene located within a field of view (FOV) of a differential imaging camera;
receiving a stream of data from the differential imaging camera, the stream of data identifying indices of pixels captured by the differential imaging camera that have changed in intensity at continuous points in time; and
generating the 3D depth map of the scene within the FOV of the differential imaging camera based upon known positions of the laser line within the FOV of the differential imaging camera and the stream of data received from the differential imaging camera.

9. The computer-implemented method of claim 8, wherein the stream of data further comprises data identifying a change in intensity of the pixels captured by the differential imaging camera.

10. The computer-implemented method of claim 8, wherein the stream of data further comprises timestamps corresponding to the pixels.

11. The computer-implemented method of claim 8, wherein the pixels define a line profile corresponding to the laser line, the line profile being observed by the differential imaging camera due to a disparity between a location of the scanning laser line projector and a location of the differential imaging camera.

12. The computer-implemented method of claim 8, wherein the differential imaging camera further comprises an optical bandpass filter having a center wavelength corresponding to an illumination wavelength of the scanning laser line projector.

13. The computer-implemented method of claim 8, further comprising scanning the laser line across only a region of interest in the FOV of the differential imaging camera, the region of interest enclosing an object of interest.

14. The computer-implemented method of claim 13, further comprising scanning the laser line across only a second region of interest in the FOV of the differential imaging camera, the second region of interest enclosing the object of interest and being calculated responsive to movement of the object of interest.

15. A device, comprising:
a scanning laser line projector;
a differential imaging camera;
a processor; and
a computer storage medium having instructions stored thereupon which, when executed by the processor, cause the device to:
cause the scanning laser line projector to scan a laser line across only a region of interest within a field of view (FOV) of the differential imaging camera;
receive a stream of data from the differential imaging camera, the stream of data identifying indices of only pixels captured by the differential imaging camera that have changed in intensity at continuous points in time; and
generate a 3D depth map of the region of interest based upon the stream of data received from the differential imaging camera and known positions of the laser line within the region of interest.

16. The device of claim 15, wherein the laser line is scanned across the region of interest at a rate equivalent to a rate used to scan the laser line across the entire FOV of the differential imaging camera.

17. The device of claim 15, wherein the laser line is scanned across the region of interest at a rate that is slower than a rate used to scan the laser line across the entire FOV of the differential imaging camera.

18. The device of claim 17, wherein the region of interest encloses an object of interest, and wherein the computer storage medium has further instructions stored thereupon to scan the laser line across only a second region of interest in the FOV of the differential imaging camera, the second region of interest enclosing the object of interest and being calculated responsive to movement of the object of interest.

19. The device of claim 15, further comprising an optical bandpass filter having a center wavelength corresponding to an illumination wavelength of the scanning laser line projector.

20. The device of claim 15, wherein the stream of data further comprises data identifying a change in intensity of the pixels captured by the differential imaging camera and timestamps corresponding to the pixels.
